(19) United States
(12) Patent Application Publication
(10) Pub. No.: US 2014/0149241 A1
(43) Pub. Date: May 29, 2014

(54) SYSTEM, METHOD AND COMPUTER PROGRAM PRODUCT FOR PROVIDING LOCATION BASED PRODUCT OR ORDER FULFILLMENT

(71) Applicants: Myles Neuneker, St. Charles, IL (US); R. Devin Neuneker, St. Charles, IL (US)

(72) Inventors: Myles Neuneker, St. Charles, IL (US); R. Devin Neuneker, St. Charles, IL (US)

(21) Appl. No.: 14/092,777

(22) Filed: Nov. 27, 2013

Related U.S. Application Data
(60) Provisional application No. 61/731,370, filed on Nov. 29, 2012.

(51) Int. Cl. G06Q 30/06; G06Q 10/08; G06Q 20/20

(52) U.S. Cl. CPC G06Q 30/0635; G06Q 20/202; G06Q 10/083
USPC 705/21

(57) ABSTRACT

Embodiments relate to a method, system and computer program product for obtaining at least one product or service using a provider's point of sale (POS) system. The method includes placing an order for at least one product or service in the POS using a mobile device; determining a geolocation of the mobile device; placing the order into a queue in the POS system; calculating a distance between the mobile device and the POS system; determining when the mobile device is within a predetermined distance of the POS system; and fulfilling the order or service when the mobile device is within the predetermined distance.

### CLAIM FOR PRIORITY

This application claims priority from U.S. Provisional Application Ser. No. 61/731,370 filed Nov. 29, 2012, the complete subject matter of which is incorporated herein by reference in its entirety.

### FIELD OF THE INVENTION

The invention generally relates to ordering products or services. More particularly, embodiments relate to a system, method and computer program product for location based product or service fulfillment.

### BACKGROUND OF THE INVENTION

Mobile phones and personal digital assistants (PDA) include functionality that may be used to order products and services remotely. However, to date, vendors have not successfully taken advantage of location information associated with customers and potential customers. Typically, a vendor only identifies the customer, if at all, when the person makes a purchase. Consequently, vendors are typically not aware of the nearby or approaching presence of a past customer, potential customer, or person seeking a product that the vender offers.

The present invention advances the art. The invention generally relates to ordering products or services. More particularly, embodiments relate to a system, method and computer program product for location based product or service fulfillment.

### BRIEF SUMMARY OF THE INVENTION

One embodiment of the invention relates to a method for obtaining at least one product or service using a provider's point of sale (POS) system. The method includes placing an order for at least one product or service in the POS using a mobile device; determining a geolocation of the mobile device; placing the order into a queue in the POS system; calculating a distance between the mobile device and the POS system; determining when the mobile device is within a predetermined distance of the POS system; and fulfilling the order when the mobile device is within the predetermined distance.

Embodiments relate to a system for obtaining at least one product or service using a method. The system includes at least one mobile device having geolocation capability; at least one provider's point of sale (POS) system; a network communicating with at least the at least one mobile device and the POS system. The method includes placing the order for at least one product or service in the POS using the mobile device; determining a geolocation of the mobile device using the mobile device geolocation capability; placing the order into a queue in the POS system; calculating a distance between the mobile device and the POS system; determining when the mobile device is within a predetermined distance of the POS system; and fulfilling the order when the mobile device is within the predetermined distance.

Other embodiments relate to computer program products for providing location based product or service fulfillment using a provider's point of sale (POS) system, the computer program products including instructions for placing the order for at least one product or service in the POS using a mobile device; instructions for determining a geolocation of the mobile device; instructions for placing the order into a queue in the POS system; instructions for calculating a distance between the mobile device and the POS system; instructions for determining when the mobile device is within a predetermined distance of the POS system; and instructions for fulfilling the order when the mobile device is within the predetermined distance.

Still other embodiments relate to a method of obtaining at least one product or service using a provider's point of sale (POS) system, the method includes placing an order for at least one product or service in the POS and determining a geolocation of a delivery location; determining a geolocation of a delivery mobile device; determining a geolocation of a purchaser mobile device; calculating a distance between the delivery mobile device and the delivery location; determining when the delivery mobile device is within a predetermined distance of the delivery location; and notifying the purchaser mobile device that the delivery mobile device is within the predetermined distance of the delivery location.

The foregoing and other features and advantages of the invention will become further apparent from the following detailed description of the presently preferred embodiments, read in conjunction with the accompanying drawings. The detailed description and drawings are merely illustrative of the invention rather than limiting, the scope of the invention can be defined by the appended the claims and equivalents thereof.

### RIEF DESCRIPTION OF THE SEVERAL VIEWS OF THE DRAWINGS

FIG. 1 is functional block diagram of a system for location based ordering in accordance with one embodiment;

FIG. 2 is a high level flow chart illustrating one method of location based ordering in accordance with one embodiment;

FIG. 3 is a diagram of a system for location based ordering similar to that of FIG. 1 illustrating the selectable predetermined distances in accordance with one embodiment;

Throughout the various figures, like reference numbers refer to like elements.

### DETAILED DESCRIPTION

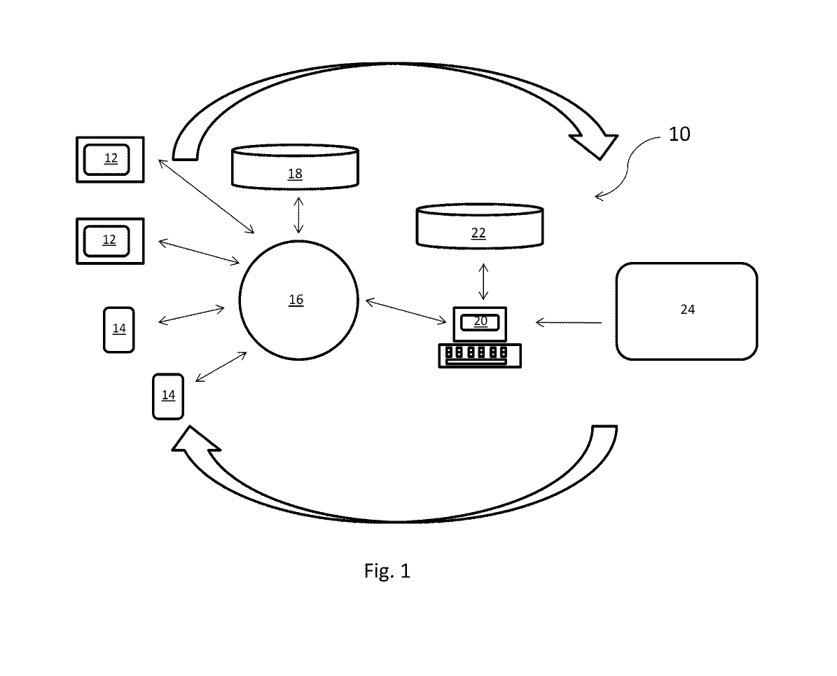

FIG. 1 depicts one embodiment of a system, generally designated 10, for obtaining at least one product or service. The system 10 includes at least one mobile device having geolocation capability communicating with at least one provider's point of sale (POS) system 20. While one mobile device is discussed, the system 10 has multiple device capability as illustrated.

FIG. 1 depicts mobile devices 12 and smart phones 14 for example having geolocation capability communicating with the POS system 20 via any wireless network. While mobile devices communicating using a wireless network are shown, any computing device and network, including GPS devices, PDA's, portable computer devices, tables, desktops and hardwire network and the like, are contemplated.

FIG. 1 illustrates the mobile devices wirelessly communicating with cloud servers/computers 16 and/or database servers/computers 18. The cloud servers 16 and/or database servers 18 communicate with the POS system 20 having one or more databases 22. Additionally, FIG. 1 illustrates a payment network 24 communicating with the POS system 20 and the mobile devices. Payment card network 24 operates between the mobile devices and the POS system 20, moving funds between the merchant banks and/or buyer bank. The payment network 24 may be an association open to all bank issuers and acquirers (e.g. VISA, MasterCard, or the like), electronic payment system such as PayPal, an association available only to certain banks (e.g. Discover, American Express, or the like), or a proprietary network available only to certain merchants (e.g. Target, Starbucks, or the like).

In at least one embodiment, the method includes placing the order for at least one product or service in the POS system 20 using the mobile devices 12/14; determining a geolocation of the mobile device 12/14 using the mobile devices' geolocation capability; placing the order into a queue in the POS system 20; calculating a distance between the mobile device and the POS system 20; determining when the mobile device 12/14 is within a predetermined distance of the POS system 20; and fulfilling the order when the mobile device 12/14 is within the predetermined distance.

Once the consumer's location has been determined via geolocation services or other means such as cell tower triangulation or GPS location transmission, the system 10 prepares for order fulfillment by the consumer. The system 10 can, preferably, take a number of actions. For example, the system 10 may select a consumer checkout code to send to the consumer to be used to confirm payment.

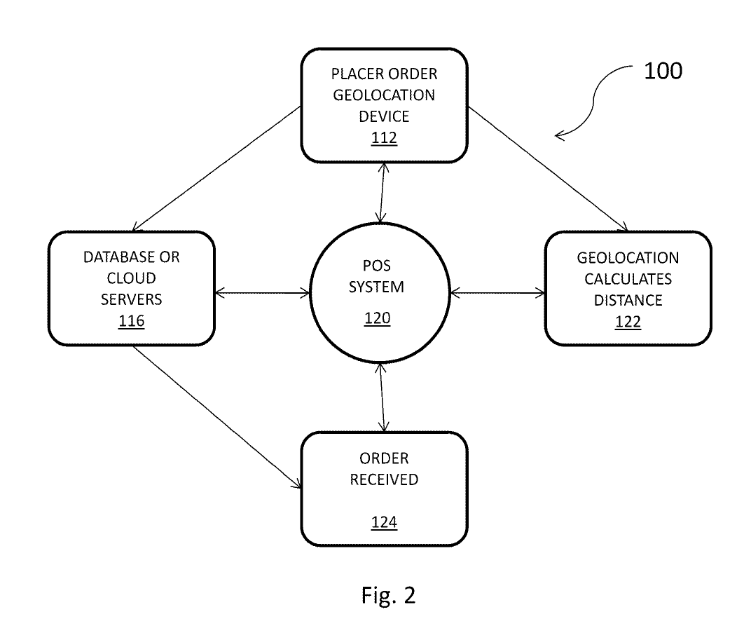

FIG. 2 depicts methods, generally designated 100, of obtaining at least one product or service using a provider's point of sale (POS) system similar to that of FIG. 1. The method 100 includes placing an order for at least one product or service in the POS system 120 using a mobile device 112 having geolocation communicating with one or more database or cloud servers, block 116. The method 100 further includes determining a geolocation of the mobile device; placing the order into a queue in the POS system 120, block 112; calculating a distance between the mobile device 112 and the POS system 120, block 122; determining when the mobile device 112 is within a predetermined distance of the POS system 120; receiving the order when the mobile device 112 is within the predetermined distance 132, block 124 and filling the order.

One or more embodiments of method 100 relate to determining when the order is filled and notifying the mobile device the order is filled, in a database for example. The method 100 may include communicating with at least the mobile device and the POS using a network, which may include at least one of a database server and a cloud server. In at least one embodiment, the method 100 may further include enabling cancelling the order prior to reaching the predetermined distance. Additionally, the method 100 may include sharing the order with multiple users, wherein the shared order is charged to one credit or debit card or different credit or debit cards.

Method 100 may further include enabling forcing the order fulfillment prior to reaching the predetermined distance. The method 100 may include placing the order into the queue in the POS system when the order is placed while the mobile device is located within the predetermined distance. In this embodiment, the order is fulfilled when the mobile device moves a predetermined distance towards the POS system.

The method 100 may include determining the location of the POS system and providing directions thereto, include storing a history of the orders, including storing a plurality of favorite products and services. In at least one embodiment, the predetermined distance is variable.

In at least one embodiment, the method 100 the predetermined distance may vary depending on the number of other orders in the queue. Alternatively, the predetermined distance is selectable between a maximum distance, a default distance, and at least one medium or middle distance between the maximum distance and default distance.

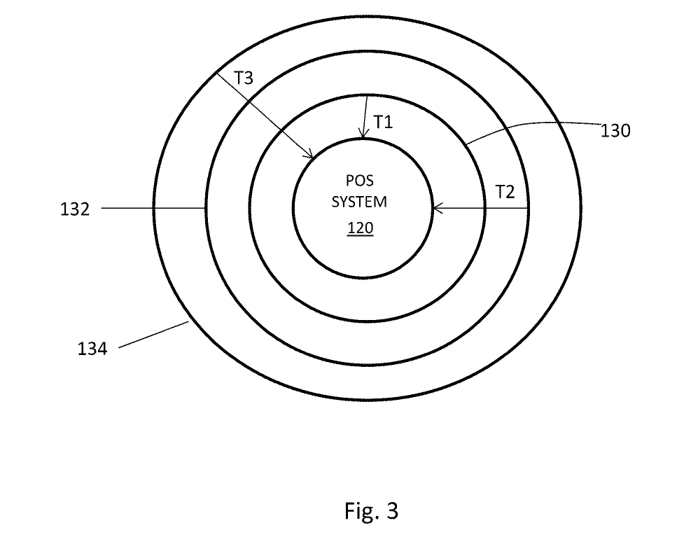

Turning now to FIG. 3, one embodiment of selecting the predetermined distances is illustrated. FIG. 3 illustrates POS system 120 having three predetermined distances automatically or manually selectable between a maximum distance 134, a default distance 130, and at least one distance 132 between the maximum distance 134 and default distance 130 (also referred to at the middle distance). In this manner it would take time T1 to travel the default distance, time T3 to travel the maximum distance, and time T2 to travel the at least one distance between the maximum distance and the default distance, where time T3 is greater than or equal to T2 and T1 and T2 is greater or equal to T1, therefore:

T3≧T2≧T1 Equation 1

It should be appreciated that while only three predetermined distances are illustrated, more than three predetermined distances are contemplated.

Other embodiments relate to computer program products for providing location based product or service fulfillment using a provider's point of sale (POS) system, the computer program product including instructions for placing the order for at least one product or service in the POS using a mobile device; instructions for determining a geolocation of the mobile device; instructions for placing the order into a queue in the POS system; instructions for calculating a distance between the mobile device and the POS system; instructions for determining when the mobile device is within a predetermined distance of the POS system; and instructions for fulfilling the order when the mobile device is within the predetermined distance.

The computer program product may include instructions for determining when the order is filled and notifying the mobile device the order is filled. Additionally the computer program product may include instructions for recording the order is filled in a database.

One embodiment of the invention relates to a method for obtaining at least one product or service using a provider's point of sale (POS) system. The method includes placing an order for at least one product or service in the POS using a mobile device; determining a geolocation of the mobile device; placing the order into a queue in the POS system; calculating a distance between the mobile device and the POS system; determining when the mobile device is within a predetermined distance of the POS system; and fulfilling the order when the mobile device is within the predetermined distance.

One embodiment relates to determining when to change or select one predetermined distance (alternatively referred to as geo-fencing) from more than one predetermined distances.

In at least one embodiment, the time to complete any order, whether busy or not should, preferably be about equal. In at least one embodiment, the Time to Complete Order (T_{CO}) equals the Time to Take an Order (T_{TO}) plus the Time to Fill an Order=T_{FO} therefore:

T_{CO=}T_{TO+}T_{FO} Equation 2

The Time to Take an Order (T_{TO}) equals the Time Queuing (T_{Q}) plus the Time to Enter an Order in the POS (T_{E}), therefore:

T_{TO=}T_{Q+}T_{E} Equation 3

The Time to Fill an Order (T_{FO}) equals the Time to Prepare an Order (T_{PO}) plus the Time to Deliver an Order to Client (T_{DC}), therefore:

T_{FO=}T_{PO+}T_{DC} Equation 4

Thus, in at least one embodiment, T_{CO=}T_{TO+}T_{FO} can be rewritten as:

T_{CO=(}T_{Q+}T_{E)+(}T_{PO+}T_{DC}) Equation 5

Assuming, that to maximize order fulfillment it is desired to keep the Time to Complete an Order (T_{CO}), the Time to Enter an Order into the POS (T_{E}) and Time to Deliver an Order to Client (T_{DC}) constant and thus these factors may be dropped out of the equation, therefore:

T_{CO=}T_{Q+}T_{PO} Equation 6

Assuming again it is desirable to keep the Time to Complete an Order constant, than an increase in Time to Prepare an Order must be offset by a decrease in Time Queuing. Similarly, a decrease in Time to Prepare an Order must be offset by an increase in Time in Queuing, thus in at least one embodiment:

T_{Q}=1/T_{PO} Equation 7

Further, in at least one embodiment, the Time Queuing is made up of two elements Time Queuing in Line (T_{QL}) and Time to Travel the Predetermined Distance (T_{TD}), therefore,

T_{Q=}T_{QL}+T_{TD} Equation 8

It should be appreciated that to keep Time to Complete an Order (T_{CO}) as constant as possible such that T_{CO=}T_{Q+}T_{PO} in an inverse relationship, than T_{QL} and T_{TD} must be inversely proportional, such that

T_{QL}=1/T_{TD} Equation 9

This means as the Time Queuing in Line increases, the Time to Travel the Predetermined Distance must decrease, while when the Time Queuing in Line decreases the Time to Travel the Predetermined Distance must increase.

Thus with respect to FIG. 3, during busy times, as the Time to Prepare an Order increases due to long queue lines and preparation times for example, there must be a corresponding decrease in the Time Queuing as provided in Equation 7. To decrease Time Queuing, the Time to Travel the Predetermined Distance must decrease as set forth in Equation 9. Therefore, with regards to FIG. 3, the predetermined distance is set (either by the system or manually) to distance 130 with a corresponding travel time of T1. However, during slow times, as the Time to Prepare an Order decrease due to short queue lines and preparation times, there must be a corresponding increase in the Time Queuing as provided in Equation 7. To increase Time Queuing, the Time to Travel the Predetermined Distance must increase as provided in Equation 9. Therefore, again with regards to FIG. 3, the predetermined distance is set (either by the system or manually) to distance 132 or 134 with a corresponding travel time of T2 or T3.

Yet another embodiment relates to a method of obtaining at least one product or service using a provider's point of sale (POS) system, the method including placing an order for at least one product or service in the POS; determining a geolocation of a delivery location; determining a geolocation of a delivery mobile device; determining a geolocation of a purchaser mobile device; calculating a distance between the delivery mobile device and the delivery location; determining when the delivery mobile device is within a predetermined distance of the delivery location; and notifying the purchaser mobile device that the delivery mobile device is within the predetermined distance of the delivery location.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A method of obtaining at least one product or service using a provider's point of sale (POS) system, the method comprising:
placing an order for at least one product or service in the POS using a mobile device;
determining a geolocation of the mobile device;
placing the order into a queue in the POS system;
calculating a distance between the mobile device and the POS system;
determining when the mobile device is within a predetermined distance of the POS system; and
fulfilling the order when the mobile device is within the predetermined distance.

2. The method of claim 1 further comprising determining when the order is filled and notifying the mobile device the order is filled.

3. The method of claim 2 further comprising recording the order is filled in a database.

4. The method of claim 1 further comprising communicating with at least the mobile device and the POS using a network.

5. The method of claim 4 wherein the network comprises at least one of a database server and a cloud server.

6. The method of claim 1 further comprising enabling cancelling the order prior to reaching the predetermined distance.

7. The method of claim 1 further comprising sharing the order with multiple users.

8. The method of claim 7 wherein the shared order is charged to one credit or debit card.

9. The method of claim 7 wherein the shared order is charged to different credit or debit cards.

10. The method of claim 1 further comprising enabling forcing the order fulfillment prior to reaching the predetermined distance.

11. The method of claim 1 further comprising placing the order into the queue in the POS system when the order is placed while the mobile device is located within the predetermined distance.

12. The method of claim 11 further comprising fulfilling the order when the mobile device moves a predetermined distance towards the POS system.

13. The method of claim 1 further comprising determining the location of the POS system and providing directions thereto.

14. The method of claim 1 further comprising storing a history of the orders.

15. The method of claim 1 further comprising storing a plurality of favorite products and services.

16. The method of claim 1 wherein the predetermined distance is variable.

17. The method of claim 16 wherein the predetermined distance varies depending on other orders in the queue.

18. The method of claim 1 wherein the predetermined distance is selectable between at least a maximum distance, a default distance, and at least one distance between the maximum distance and default distance.

19. A system for obtaining at least one product or service using a method, the system comprising:
at least one mobile device having geolocation capability;
at least one provider's point of sale (POS) system;
a network communicating with at least the at least one mobile device and the POS system;
the method comprising:
placing the order for at least one product or service in the POS using the mobile device;
determining a geolocation of the mobile device using the mobile device geolocation capability;
placing the order into a queue in the POS system;
calculating a distance between the mobile device and the POS system;
determining when the mobile device is within a predetermined distance of the POS system; and
fulfilling the order when the mobile device is within the predetermined distance.

20. The system of claim 19 wherein the network comprises at least one of a database server and a cloud server.

21. A computer program product for providing location based product or service fulfillment using a provider's s point of sale (POS) system, the computer program product including instructions comprising:
instructions for placing the order for at least one product or service in the POS using a mobile device;
instructions for determining a geolocation of the mobile device;
instructions for placing the order into a queue in the POS system;
instructions for calculating a distance between the mobile device and the POS system;
instructions for determining when the mobile device is within a predetermined distance of the POS system; and
instructions for fulfilling the order when the mobile device is within the predetermined distance.

22. The computer program product of claim 21 further comprising instructions for determining when the order is filled and notifying the mobile device the order is filled.

23. The computer program product of claim 22 further comprising instructions for recording the order is filled in a database.

24. A method of obtaining at least one product or service using a provider's point of sale (POS) system, the method comprising:
placing an order for at least one product or service in the POS;
determining a geolocation of a delivery location:
determining a geolocation of a delivery mobile device;
determining a geolocation of a purchaser mobile device;
calculating a distance between the delivery mobile device and the delivery location;
determining when the delivery mobile device is within a predetermined distance of the delivery location; and
notifying the purchaser mobile device that the delivery mobile device is within the predetermined distance of the delivery location.
